(19) United States
(12) Patent Application Publication
(10) Pub. No.: US 2010/0235848 A1
(43) Pub. Date: Sep. 16, 2010

(54) SYSTEM AND METHOD FOR PROVIDING AUTOMATIC ADVERTISING DISTRIBUTION FOR ONLINE COMPUTER USERS

(76) Inventors: Selina Lam, Castro Valley, CA (US); Richard Aaron Neal Shusterman, Los Gatos, CA (US); Lawrence Illg, Aarhus (DK)

Correspondence Address: SCHWEGMAN, LUNDBERG & WOESSNER/EBAY, P.O. BOX 2938, MINNEAPOLIS, MN, 55402, US

(21) Appl. No.: 12/489,863

(22) Filed: Jun. 23, 2009

Related U.S. Application Data
(60) Provisional application No. 61/159,399, filed on Mar. 11, 2009.

(51) Int. Cl. G06F 9/44

(52) U.S. Cl. 719/328

(57) ABSTRACT

A system and method for providing automatic advertising distribution for online computer users is disclosed. A particular embodiment includes obtaining a listing posted by a first user in a first region; processing the listing according to a set of pre-defined rules related to posting a listing in a second region, the processed listing being modified to produce a second version of the listing; pushing the second version of the listing to a server in the second region; and making the second version of the listing available for viewing by a second user in the second region.

### PRIORITY APPLICATION

This non-provisional patent application claims the benefit of the filing date of U.S. Provisional Patent Application Ser. No. 61/159,399, filed on Mar. 11, 2009, entitled, “SYSTEM AND METHOD FOR PROVIDING AUTOMATIC ADVERTISING DISTRIBUTION FOR ONLINE COMPUTER USERS”, and assigned to the same assignee as the present patent application.

### TECHNICAL FIELD

This application relates to a method and system for use with an electronic commerce system, according to one embodiment, and more specifically, for providing automatic advertising distribution for online computer users.

### BACKGROUND

Buying consumer products and services, such as advertising, in a market place full of choices can often be a tedious task. The shopping process for on-line users can be even more difficult. Online shopping can be made more difficult when listings of items for sale or rent are provided in different languages and with pricing in different national currencies. From the perspective of goods or service providers, it would be beneficial to expose a particular listing to as many potential consumers as possible, regardless of where the potential consumer is located. From the perspective of goods or service consumers, it would be beneficial to easily search for listings of interest from as many providers as possible. In a particular example, a vacation rental real estate market can span multiple countries where providers and consumers may communicate in different languages and transact using different currencies. Existing online systems are typically localized and cannot provide a regional or global reach. As such, potential consumers have to visit multiple local sites to view listings of interest. Providers may lose sales to potential consumers who are not local.

Thus, a system and method for providing automatic advertising distribution for online computer users is needed.

### BRIEF DESCRIPTION OF THE DRAWINGS

The various embodiments is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of multiple network and marketplace applications, respectively, which are provided as part of a network-based marketplace;

FIG. 3 is a high-level entity-relationship diagram, according to an example embodiment, illustrating various tables that may be maintained within a database to support networking and marketplace applications;

FIG. 4 is a system diagram illustrating an example embodiment of the system in which an advertising distribution server of a particular embodiment can operate.

FIG. 5 is a block diagram illustrating an example embodiment of the components of an advertising distribution engine of a particular embodiment;

FIG. 6 is a processing flow chart illustrating an example embodiment of an advertising distribution engine as described herein.

FIG. 7 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In one embodiment, a system and method for providing automatic advertising distribution for online computer users is disclosed. In various example embodiments, an application aims to simplify and facilitate the shopping experience on a host site, such as a classified advertising site, an on-line commerce site, an auction site, or other product/service or broker site. A particular embodiment can use an application programming interface (API) Web application that can make use of host site search and other API's to provide search results to buyers in a simpler format. Search results and can be customized according to user profile information associated with one or more particular consumers and information related to particular products, listings, or advertisements. The user profile information can be generated and processed based on user/consumer responses to queries prompted by the system.

In a particular example embodiment, a central classified ad repository (denoted a hub) pro-actively and automatically gathers advertisement (ad) postings (i.e., listings) from a local site and pulls the ads to the central repository. The pulled ads are processed for posting to a pre-configured set of destination sites that may be other local sites, regional sites, or global sites. Processing includes currency conversion, time conversion, metric conversion, and some forms of language translation. Then the processed ads are pushed to the destination sites.

In a particular example embodiment, the central repository can use well-known screen-scraping techniques and application programming interfaces (API's) to get ads from source sites. Tracking is used to determine if new ads have been posted or deleted from the source site for each gathering cycle. A single unique ad identifier (id) can be used. In this manner, the ad can be viewed in and shared across multiple sites without being duplicated. A single description in an ad can have multiple language translations and multiple currencies associated with the ad. The appropriate combinations of content of the ads can be exposed to a particular consumer based on the site viewing the ad and the profile of the consumer viewing the ad.

Applications for the described system and method include property rental ads, auto ads, and job ads. Conventional systems and methods don't pro-actively and automatically gather ad postings. Conventional techniques require an ad poster to manually push the ad to a central hub. Typically, conventional systems also don't distribute listings across country boundaries. Conventional systems also require agent software installed on a local site, which can be difficult to get installed and to administer.

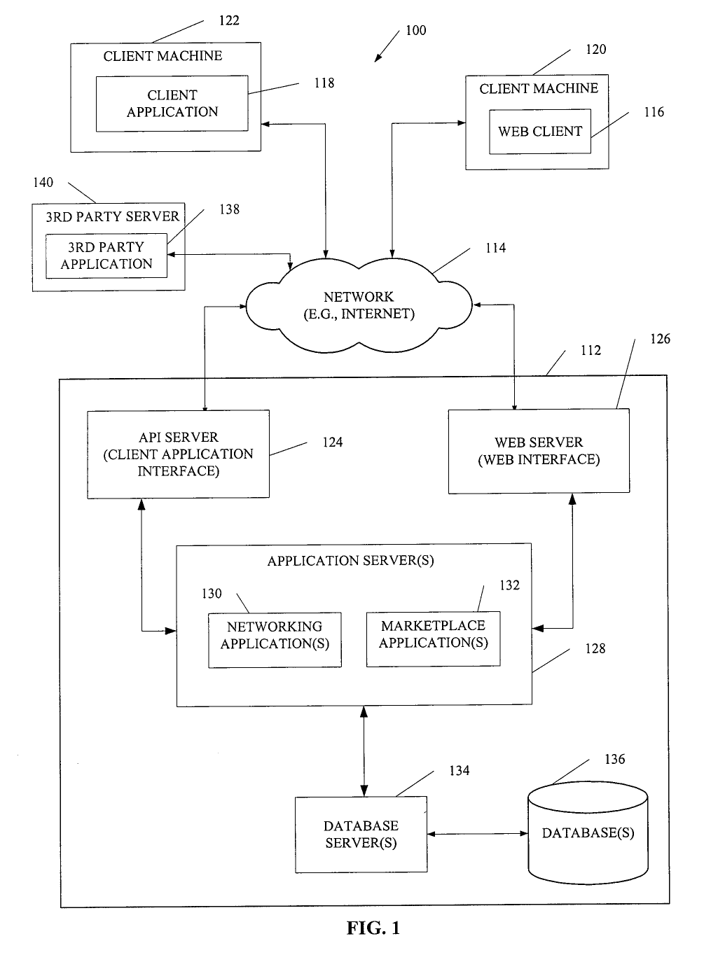

FIG. 1 is a network diagram depicting a network system 100, according to one embodiment, having a client-server architecture configured for exchanging data over a network. For example, the network system 100 may be a trading/commerce system where clients may communicate and exchange data with the trading/commerce system, the data may pertain to various functions (e.g., online purchases) and aspects (e.g., managing social networks) associated with the network system 100. Although illustrated herein as a client-server architecture for simplicity, in other embodiments the network architecture may vary and include an architecture such as a peer machine in a peer-to-peer (or distributed) network environment.

Returning to FIG. 1, a data exchange platform, in an example form of a network-based provider (or host system/site) 112, provides server-side functionality, via a network 114 (e.g., the Internet) to one or more clients. The one or more clients may include users that may utilize the network system 100 and more specifically, the network-based provider 112, to exchange data over the network 114. These transactions may include transmitting, receiving (communicating) and processing data to and from the multitude of users. The data may include, but is not limited to, user preference information, user profile information, classified ad search queries, shopping or listing context information and/or identifiers, context data, notations (e.g., personal and public shopping notes), context filter data, shared electronic shopping carts, product and service reviews, product, service, manufacture, and vendor recommendations and identifiers, product and service listings associated with buyers and sellers, auction bids, feedback, etc. In one embodiment, the user profile information can be associated with one or more contexts generated by a user or other users and maintained on the network-based provider 112. Data associated with a user profile, such as any of the data described above, may be publicly shared as determined by the originator of the data.

Turning specifically to the network-based marketplace 112, an application program interface (API) server 124 and a web server 126 are coupled to, and provide programmatic and web interfaces respectively to, one or more application servers 128. The application servers 128 host one or more networking application(s) 130 and marketplace application(s) 132. The application servers 128 are, in turn, shown to be coupled to one or more databases servers 134 that facilitate access to one or more databases 136.

In one embodiment, the web server 126 may send and receive data pertaining to a user profile or item listing via a toolbar installed on a browser application. The toolbar may allow for a user or a third party to, inter alia, create a new user profile (a profile creator), selectively add a uniform resource locator (URL) associated with the created user profile, and create notations regarding research and general matters associated with the user profile. In other embodiments, the web server may serve a page or the API server 124 in conjunction with the client application 118 may provide the same or similar functionality as that described with reference to the toolbar. It may be noted that using a toolbar within an application such as a browser or stand alone application is well known in the art.

The marketplace application(s) 132 may provide a number of marketplace functions and services (e.g., item listings, searching, advertisement, payment, etc.) to users that access the network-based marketplace 112. The networking application(s) 130 likewise may provide a number of consumer services, merchant services, or social networking services and functions to users. The networking application(s) 130 may allow a user to generate one or more contexts related to shopping or advertisement (ad) generation, which may include listings (e.g., for products and services) couched as a broad category associated with a consumer, a class of consumers, and/or an item (e.g., a product or service or a listing for a product or service) or class of items. Additionally, listings can be couched as associated with a specific consumer or a specific item. For example, listings in the form of a category could be, “digital cameras” or “plumbers.” Similarly, a context can include a user profile associated with a category of users or a specific user. For example, a user profile in the form of a category could be, “women over 40 years old” or “purchasers of digital cameras.” An example of a user profile in a more specific form may be, “a user profile for John A. Smith of Akron, Ohio” or “purchasers of Canon digital cameras.” The level of specificity may vary and is selectable by the user profile creator or administrator of the advertising distribution engine of a particular embodiment. For example, the user profile can be as specific as a particular person or the associated listing associated with a make, model, additional specific attributes or features of a specific item or service offered for sale or lease.

In one embodiment, the networking application(s) 130 and marketplace application(s) 132 may provide a client (e.g., web client 116) with an interface that includes input fields for personality or item/listing attributes most commonly selected by other users as the most important or most determinative attributes related to the products/services which a user/consumer is seeking or selling. For example, a multitude of users may have indicated they thought the most important personality attributes for the user profile include information related to: 1) consumer/user need, 2) general consumer/user personality, 3) consumer/user shopping attitude, and 4) consumer/user budget. A multitude of other users may have indicated they thought the most important item attributes for a digital camera purchaser user profile include: 1) digital camera brand, 2) pixel count, 3) zoom, and 4) size. These user profile attributes may be independently developed or discovered by the network-based marketplace 112 by processing the attribute data received from the multitude of users or may be based on the user profile creator ranking the attributes or a combination thereof.

The networking application(s) 130 may allow the user profile creator or advertising distribution engine user to distribute the one or more user profiles to one or more groups defined by the user profile creator or advertising distribution engine user (e.g., “my family,” “my friends,” etc.) or to groups at various levels in a predefined category (e.g., “photography group,” “digital camera group,” or “Canon digital camera group,” etc.).

While the networking application(s) 130 and the marketplace application(s) 132 are shown in FIG. 1 to form part of the network-based marketplace 112, it will be appreciated that, in alternative embodiments, the networking application(s) 130 may form part of a social networking service that is separate and distinct from the network-based marketplace 112.

FIG. 1 also illustrates a third party application 138, executing on a third party server machine 140, as having programmatic access to the network-based marketplace 112 via the programmatic interface provided by the API server 124. For example, the third party application 138 may, utilizing information retrieved from the network-based marketplace 112, support one or more features or functions on a website hosted by the third party. The third party website may, for example, provide one or more networking, marketplace or payment functions that are supported by the relevant applications of the network-based marketplace 112.

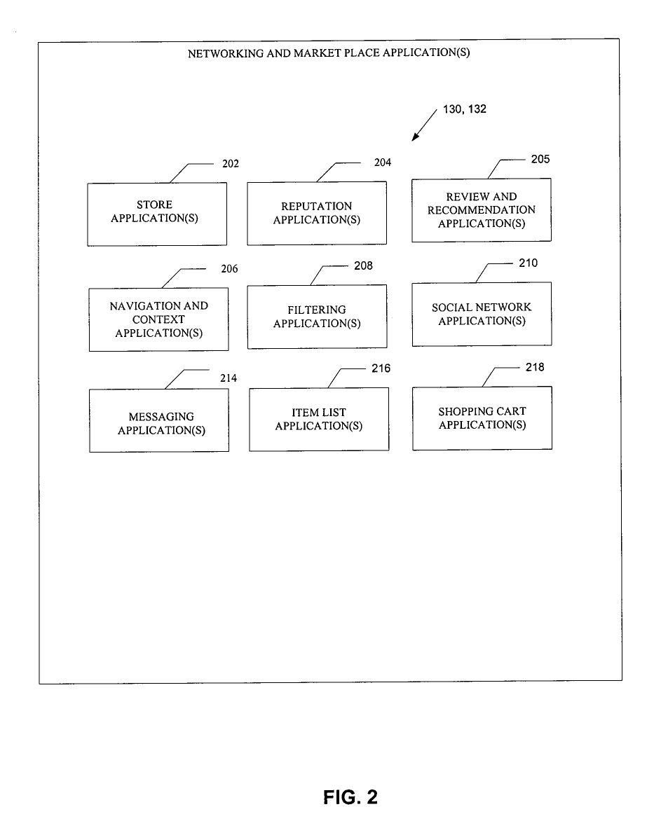

FIG. 2 is a block diagram illustrating an example embodiment of multiple network and marketplace application(s) 130 and 132, respectively, which are provided as part of the network-based marketplace 112. The network-based marketplace 112 may provide a number of classified listings for goods and/or services, category-based shopping, social networking, and purchase and bidding systems, various levels of features provided for users, and price-setting mechanisms whereby a seller may list goods and/or services (e.g., for sale, bid, or lease) and a buyer may buy or bid on listed goods and/or services. A user profile and context associated with a user shopping or listing an item in the network-based marketplace 112 may offer or provide information that may be helpful in assisting the advertising distribution engine user in customizing their shopping or listing experience pertaining to the user profile or listing information (i.e., context). Among various embodiments, the recommendations, reviews, or research notes corresponding to the user profile or listing information may be directed from another user to one or more users desiring data associated with the user profile or listing information or the data may be provided from storage by the network and marketplace application(s) 130 and 132 based on the user profile or listing information provided by a user. The data may be provided based on a request from the user profile creator or automatically pushed to the user profile creator based on policy or a user configuration file.

To this end, the network and marketplace application(s) 130 and 132, respectively, are shown to include one or more application(s) which support the network-based marketplace 112, and more specifically the generation and maintenance of one or more user profiles provided by users of the network-based marketplace 112 or advertising distribution engine users. These applications can include support for activities associated with the user profiles and listing information, including storing and retrieving user notes, web sites (URLs), links associated with related tags, research and notes from other users and community members, related community groups, vendors, providing localized geographic data for user profiles (e.g., regional consumer purchasing patterns), etc. Additionally, the various applications may support social networking functions, including building and maintaining the community groups created by a user, which may be helpful in providing various types of data (e.g., reviews, notes, local services, consumer information, etc.) pertaining to the user profiles and listing information.

Store application(s) 202 may allow sellers to group their listings (e.g., goods and/or services) within a “virtual” store, which may be branded and otherwise personalized by and for the sellers. Such a virtual store may also offer promotions, incentives and features that are specific and personalized to a relevant seller and consumer. In one embodiment, based on the user profiles provided by the user profile creator, the virtual store may be provided to the user profile creator or advertising distribution engine user where the virtual store may carry or sell an item or service related to a user's need based on the user profile.

Reputation application(s) 204 may allow parties that transact utilizing the network-based marketplace 112 to establish, build, and maintain reputations, which may be made available and published to potential trading partners. Consider that where, for example, the network-based marketplace 112 supports person-to-person trading, users may have no history or other reference information whereby the trustworthiness and/or credibility of potential trading partners may be assessed. The reputation application(s) 204 may allow a user, for example through feedback provided by other transaction partners, to establish a reputation within the network-based marketplace 112 over time. Other potential trading partners may then reference such a reputation for the purposes of assessing credibility, trustworthiness, or the like. A user creating a user profile and seeking reviews, research (e.g., notes, etc.), and recommendations associated with the profile may filter the result data from the search or context submission based on reputation data. For example, the user profile creator may only want profile data such as reviews and research notes pertaining to the user profile from other users with a greater than 3 out of 5 star reputation rating.

In one embodiment, the network-based marketplace 112 includes review and recommendation application(s) 205. The social networking application(s) 210 may work in conjunction with the review and recommendation application(s) 205 to provide a user interface to facilitate the entry of reviews of the user profile data received from other users. A review may be a text entry of the community group member's opinion, a standard review form including check boxes indicating a level satisfaction, or a combination of both, etc. Recommendations may include a specific type of demographic, item, a specific brand or service for a type of item, a specific retailer for the item, etc.

Navigation of the network-based marketplace 112 may be facilitated by one or more navigation and context application(s) 206. For example, a context application may, inter alia, enable key word searches of item listings associated with a context defined by a user profile of a particular consumer. The context can include an association between the user profile data in the user profile and item feature sets related to items in the item listings. The item listings can include listings from a group including products or services or both. The item feature set data and data defining the association between the user profile data in the user profile and item feature sets may be retrieved from the network-based marketplace 112 (e.g., databases 136) or from various other remote sources, such as other network sites, other users (e.g., experts or peers), etc. In one embodiment, a toolbar installed on a browser application may be used for functions including interactive and navigation functions to create a new user profile, selectively add a uniform resource locator (URL) associated with the created user profile, and create notations regarding research and general matters associated with the user profile. These functions may be user accessible by many methods known in the art, including a web form interface (HTML or embedded Java) or a stand alone application interface. For example, a navigation application may include a browser that allows users via an associated user interface to browse a user's user profile, various item listings, item feature sets, contexts, catalogues, inventories, social networks, and review data structures within the network-based marketplace 112. In one embodiment, the user interface includes selectable elements in the form of tabs to separate out various categories of user profile data that when selected generate a list associated with the category. For example, a tab for “My Notes,” a tab for “Everyone's Notes,” a tab for “Buy,” and a tab for “Sell”. Various other navigation applications (e.g., an external search engine) may be provided to supplement the search and browsing applications.

In one embodiment, using filtering application(s) 208, the user or advertising distribution engine user may customize result data associated with a user profile or listing search results. The filtering application(s) 208 may generate the result data according to one or more rules provided by the network-based marketplace 112 and the user receiving the filtered result data. For example, as discussed above with reference to the reputation application(s) 204, the user may only want the user profile to match on item listings pertaining to item reviews from other users with a greater than 3 out of 5 star reputation rating. In another example, the user may only want user profile data to match on item listings pertaining to item listings with a particular feature set or attribute set. For example, the user may only want result data for digital cameras with equal or greater than 5 megapixels. Additionally, the filtering rules may be combinable or modifiable to broaden or narrow the scope of the result data. The filtering application(s) 208 may also be used to implement rules for granting or allowing access to the user profile data.

Messaging application(s) 214 may be used for the generation and delivery of messages to users of the network-based marketplace 112. For example, the user may like a particular review or research from another user and may wish to contact the user for additional information. In one embodiment, the messaging application(s) 214 may be used in conjunction with the social networking application(s) 210 to provide promotional and/or marketing (e.g., targeted advertisements associated with the user profile) to the user or a related user from vendors and community members that may have offerings related to the user profile.

Item list application(s) 216 may be used in the network-based marketplace 112 by the user to create an item list based on selecting one or more items and services to purchase (or sell, auction, lease, or donate), which may be at least partially based on result data associated with the user's shopping experience. The item list application(s) 216 may be accessed via a user interface that allows the user to create and use the item list. Additionally, the user may selectively share this list within a community or to all users to gain or solicit additional data such as vendor recommendations for each purchase or vendor reviews for vendors that may be present in the list.

In one embodiment, electronic shopping cart application(s) 218 are used to create a shared electronic shopping cart used by a user to add and store items from a shopping list generated by the user (e.g., by making selections from a “Buy” tab). The electronic shopping cart application(s) 218 may facilitate the transactions for each item on the list by automatically finding the items in the electronic shopping cart across at least one or all of a set of vendors, a comparison shopping site, an auction site, other user's ads, etc. In one embodiment, a multitude of transactions may appear as one transaction based on the selection of “Bulk Purchase.” In various embodiments, the selection criteria for which vendor or vendors to purchase from may include, but is not limited to, criteria such as lowest cost, fastest shipping time, preferred or highest rated vendors or sellers, or any combination thereof.

It will be appreciated that one or more of the various example networking and marketplace application(s) 130, 132 may be combined into a single application including one or more modules. Further, in some embodiments, one or more applications may be omitted and additional applications may also be included.

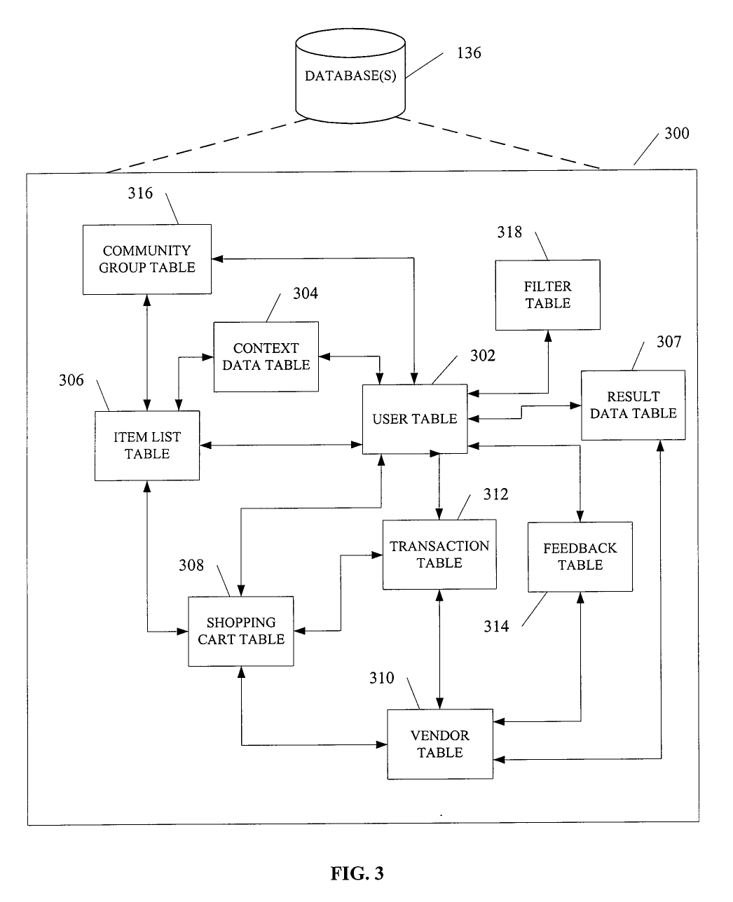

FIG. 3 is a high-level entity-relationship diagram, in accordance with an example embodiment, illustrating various tables 300 that may be maintained within the database(s) 136 (see FIG. 1), which may be utilized by and support the networking and marketplace application(s) 130 and 132, respectively. A user table 302 may contain a record for each registered user of the network-based marketplace 112, and may include identifier, address and financial instrument information pertaining to each such registered user. In one embodiment, a user operates as one or all of a user profile creator, a seller, a buyer, within the network-based marketplace 112.

The context data table 304 maintains a record of the one or more user profiles and/or listings created by or related to a user. As discussed above, this may include user profile identifiers and/or listing identifiers that may include words and/or phrases from the general to the specific for a consumer class, specific consumer, product/service class, or a specific product/service. Context data in context data table 304 can also include associations between the user profile data in the personalized consumer profiles and item feature sets related to items in the item listings. The item listings can be listings for products or services or both. The personalized consumer profiles, item feature set data, and data defining the association between the user profile data in the personalized consumer profiles and item feature set data may be stored into or retrieved from the context data table 304 of database(s) 136. In one embodiment, each word in a phrase may be a tag linked to another user profile and its associated data. For example “Canon” may be a selectable element within the user interface as a tag that results in the selector receiving more general data regarding Canon products. Similarly, “camera” may be selected to receive more general data regarding cameras, in this case both digital and film cameras.

The tables 300 may also include an item list table 306 which maintains listing or item records for goods and/or services that were created using the item list application(s) 216. In various embodiments, the item list may be created and shared with a community group or to all users in part to solicit feedback regarding listed or potential vendors.

Each listing or item record within the item list table 306 may furthermore be linked to one or more electronic shopping cart records within a electronic shopping cart table 308 and to one or more user records within the user table 302 and/or a vendor table 310, so as to associate a seller or vendor and one or more actual or potential buyers from the community group with each item record.

A transaction table 312 may contain a record for each transaction pertaining to items or listings for which records exist within the item list table 306. For example, the transaction table 312 may contain a purchase or sales transaction of an item of the item list by a consumer.

In one example embodiment, a feedback table 314 may be utilized by one or more of the reputation application(s) 204 to construct and maintain reputation information associated with users (e.g., members of the community group, sellers, etc.).

Group(s) of users found in a community group table 316 may be selected by a user to be members of a community group having access to user profile data and an item listing associated with the electronic shopping cart.

A filter table 318 may be used to sort and filter data associated with a user profile. The sorted or filtered data are then stored in the result data table 307 and linked to the user profile creator via a user profile identifier. Various types of filters and associated rules were discussed above with reference to the filtering application(s) 208 in FIG. 2.

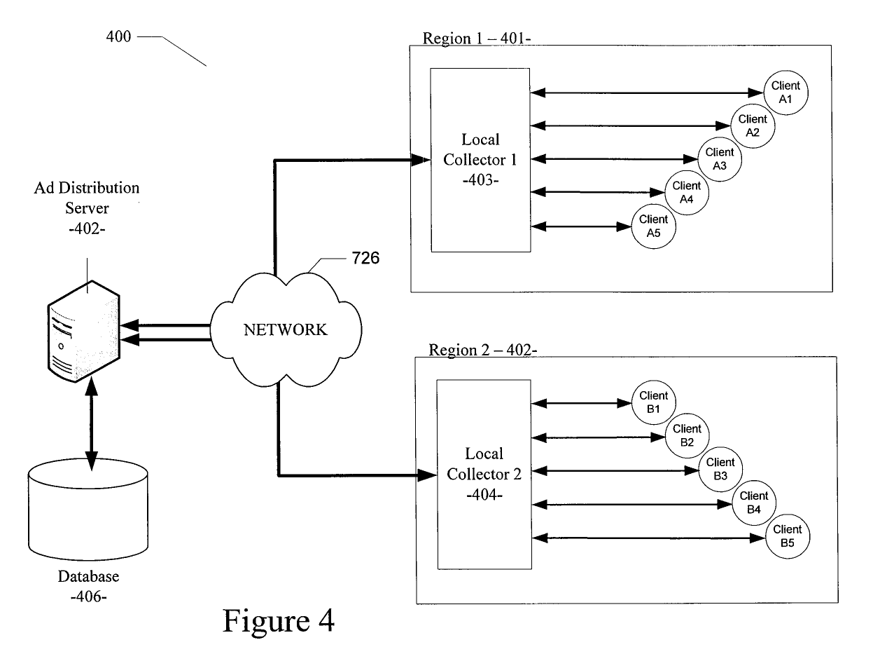

FIG. 4 is a system diagram illustrating an example embodiment 400 of the system in which an advertising distribution server 402 of a particular embodiment can operate. As shown, the advertising distribution server 402 can communicate via a network 726 with a plurality of local collectors 403 and 404, which can collect posted listings at a local level from a plurality of local clients. Each local collector 403 and 404 can collect listings in a region 401 and 402, respectively. Typically, the local collectors 403 and 404 collect listings created in a particular native language and including pricing information in a particular local currency. As described herein, the advertising distribution server 402 can pro-actively and automatically gather ad postings (i.e., listings) from a local site, such as local collector 403, and pull the collected ads to the central repository 406. The collected ads can be processed for posting to a pre-configured set of destination sites that may be other local sites, regional sites, or global sites, such as local collector 404. Processing performed on the collected ads can include currency conversion, time conversion, metric conversion, and some forms of language translation. Then the processed ads can be pushed to the destination sites in a different region.

In a particular embodiment, a sample operational flow is as follows:
Client application posts a new ad to the listing service (e.g., collector 403).
On the client application, the user is asked if they want the text in their ad translated into another language
User pays for translation service or business decides that an ad will be translated and specifies the destination languages
A Translator in the ad distribution server 402 translates the text in the ad
Other clients (e.g., clients connected to collector 404) can search for and retrieve ads based on a different language

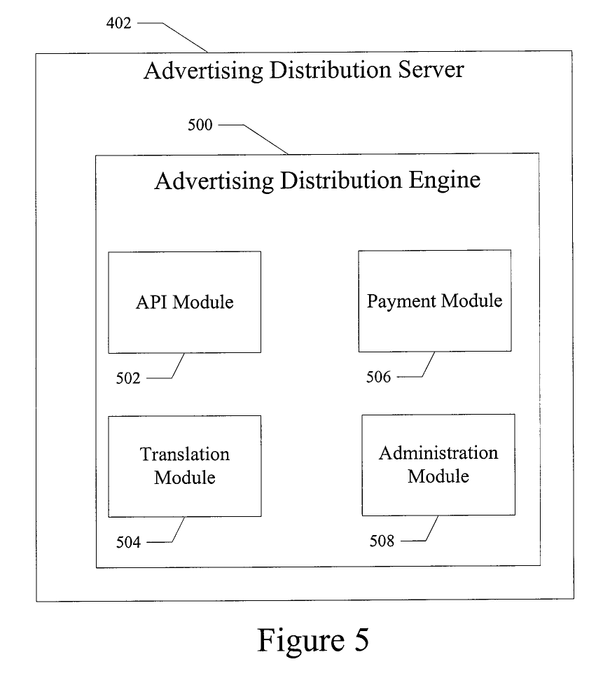

FIG. 5 illustrates an example embodiment of functional modules or tools pertaining to the advertising distribution engine 500 of a particular embodiment. It will be appreciated that the applications and associated modules may be executed within any portion of the network system 100, (e.g., the server machine 112). Additionally, the modules discussed herein are for example only and it can be appreciated these modules and applications may be combined into one or many modules and applications without departing from the spirit of the methods and systems described herein.

In the particular embodiment, the ad distribution server 402 may include an ad distribution engine 500. The ad distribution engine 500 of a particular embodiment, as shown in FIG. 5, can include a number of features, applications, services, tools, or modules, such as:
API Module 502—APIs for an ad listing service (e.g., collector 403)
Translation Module 504—Translation of the text in the ads
Payment Module 506—A payment tool to accept payment to translate the text in the ads
Administration Module 508—An Administration tool for Administration/monitoring/reporting of these server applications

These ad distribution engine 500 modules of a particular embodiment are described in more detail below.

In a particular embodiment, the database 406 can include the following elements:
The database can be used to store data for the server 402 application.
The database can have tables to store all data posted by the features described herein.
An ad table can contain the ads as posted by clients. This table can be considered the source of record for the original ad content.
The database can contain a separate ad table to store alternate, translated versions of the ads.
The database can contain a table to store configurable language mappings defining:
   If an ad posted by one client will require translation
   The languages into which the ad can be translated
   How an ad from one client can be distributed to other clients
The database can contain a table to store foreign exchange rates.
The database can contain a table to track translation requests and activity.
The database does not typically need to store any financial information or personal identifiable information (PII).

### Application Programming Interface (API) Module 502

All APIs supported by the API module 502 can be based on a Service Oriented Architecture. When responding to a “post” request by the client, the API can write ads into a database table and reply back to the client with success or failure codes. If the ad is a new ad, a new record can be created in the database. If the ad is an existing ad, the existing record can be updated. Some of the fields of the ads in an example embodiment include:
Ad Identifier (ID) (typically a unique ID)
Title
Description
Price
Poster's email address
Source client of the ad
Source language of the ad
Translation request flags (to identify ads that require translation to n languages)
Translation complete flags (to identify ads that are translated to n languages)

When responding to a “search” request by the client, the API can query the database tables and return the ad IDs requested by the client. Some of the filters the clients can use include:
Language of the ad (source or translated)
New or updated ads since the last search request

Clients can use a “get” request to retrieve the details of individual ads from the listing service. All fields are returned, including alternate translations and currencies.

Foreign exchange rates batch job
A batch job can be written to execute daily
The batch job can update the prices recorded in an ad based on daily foreign exchange rates provided by Bloomberg

### Administration/Monitoring/Reporting Module 508

The administration/monitoring/reporting tool of Administration module 508 can be a web application with an English only interface. The tool can be used by an internal business team. Administration can allow the business to manage ads and the server applications. Some administration functionalities of a particular embodiment include:
Configure the frequency of the batch jobs
Configure source/destination client, language, and data mapping between the source and alternate ad tables
View content of an ad, in the source and alternate tables based on filters, such as client ID and language
Mark an ad as requiring translation and then specify the destination languages. If an ad is marked in the tool as requiring translation, the record in the source table can be updated:
   The ad is flagged for translation
   The destination languages are stored

Monitoring can notify the business team of problems encountered during service execution. Some notifications of a particular embodiment include:
Send an alert when request initiated by the client fails to execute completely
Display the error(s) causing a failure and provide process to troubleshoot issues
Allow the business to manually start or stop batch jobs
Show the progress of a batch process while it is executing

The reporting functionality can help the business gauge the supply of ads and demand for the translation service. Some reports of a particular embodiment include:
The number of ads posted and retrieved based on client ID
The number of ads that failed to be posted or retrieved based on client ID
The number of ads requested for translation based on client ID
The number of ads translated per client ID
The number of ads per language

### Payment Module 506

The payment tool of payment module 506 can be a web application. All text in the tool can be externalized for localization to other languages. The tool can allow the user to identify himself/herself using the email address listed for the ad. The tool can display a list of the ads associated with the email address. The tool can display the ad content in a separate window for the user to view the ad and confirm the ad for translation. The tool's User Interface (UI) can display the user's original ad and allow the user to choose the language(s) for translation (based on the language mapping stored in the database). The tool can calculate the appropriate price based on the selection. The tool can then redirect the user to a payment gateway such as PayPal or Bibit to send the actual payment. No financial information or PII needs to be stored on the application server.

### Translation Module 504

The translation tool of Translation Module 504 can be a web application with an English only interface. The tool can support administrator accounts and user accounts for the translators. The tool can be able to report, per language, the number of ads for each translation status. The tool can have a queue for each destination language. Translation activities can be based on a workflow that is configurable by the business. A sample workflow for a particular embodiment follows:
Ad is flagged for translation by the client application or by the business (via the administration tool). Translation status=translation requested.
Per language, the tool lists the ads that with status=translation requested or translation in progress.
The translator selects an ad from the list and clicks on a “translate” button. This action updates the status to “translation in progress” and the ad moves to the next step in the workflow.
For ads with status “translation in progress”, the tool's user interface (UI) can have a panel displaying the text content of an ad on one side of the screen and another panel on the other side of the screen for the translated text.
The translator can be able to save the new text during the translation by clicking on a “save” button. This action does not change the translation status. A new record in the alternate table in the database. The translation status, destination language, and timestamp can be recorded. If the record already exists in the alternate table, the record can be updated.
When the translation is done, the translator can click on a “submit” button. This action updates the status to “translation complete” and the ad is removed from the queue
   If the translated text already exists in the alternate table in the database (translated text was once saved), the record can be updated.
   If the translated text does not exist in the alternate table (translated text was never saved), a new record for the translated text can be stored in the alternate table in the database. The translation status, destination language, timestamp can be recorded.

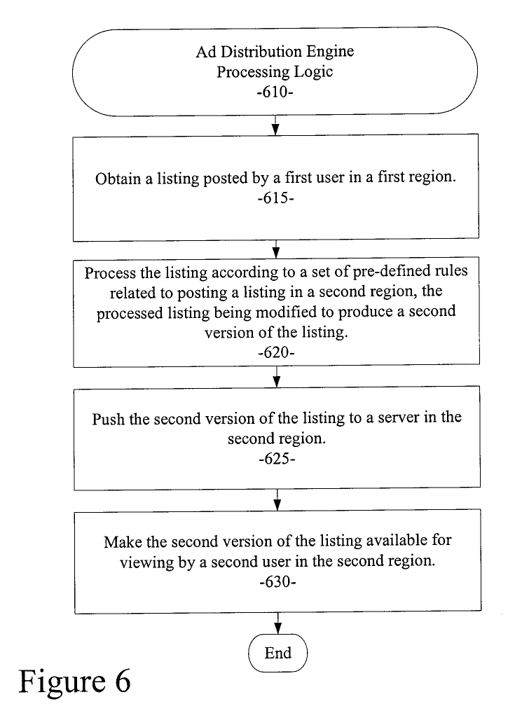

FIG. 6 is a processing flow chart illustrating an example embodiment 610 of an advertising distribution engine as described herein. The method of an example embodiment includes: obtaining a listing posted by a first user in a first region (processing block 615); processing the listing according to a set of pre-defined rules related to posting a listing in a second region, the processed listing being modified to produce a second version of the listing (processing block 620); pushing the second version of the listing to a server in the second region (processing block 625); and making the second version of the listing available for viewing by a second user in the second region (processing block 630).

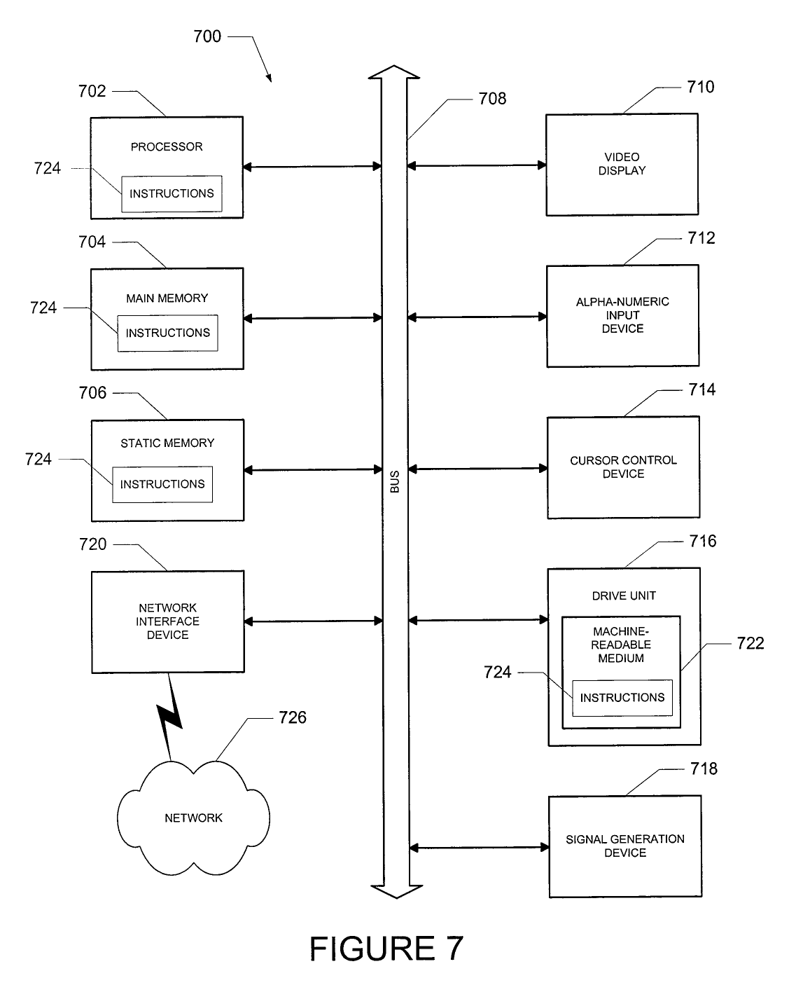

FIG. 7 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, including:
obtaining a listing posted by a first user in a first region;
processing the listing according to a set of pre-defined rules related to posting a listing in a second region, the processed listing being modified to produce a second version of the listing;
pushing the second version of the listing to a server in the second region; and
making the second version of the listing available for viewing by a second user in the second region.

2. The method as claimed in claim 1 wherein obtaining the listing includes performing a screen-scraping operation.

3. The method as claimed in claim 1 wherein obtaining the listing includes performing an access to an ad source via an application programming interface (API).

4. The method as claimed in claim 1 wherein processing the listing includes performing a currency conversion operation on an object included in the listing.

5. The method as claimed in claim 1 wherein processing the listing includes performing a time conversion operation on an object included in the listing.

6. The method as claimed in claim 1 wherein processing the listing includes performing a language conversion operation on an object included in the listing.

7. The method as claimed in claim 1 including tracking an ad source to determine if new ads have been posted or deleted from the ad source.

8. The method as claimed in claim 1 wherein the first region and the second region are in different countries.

9. A system, comprising:
a processor;
a database, in data communication with the processor, for storage of listings obtained from a plurality of regions; and
an advertising distribution module, executable by the processor, to obtain a listing posted by a first user in a first region, process the listing according to a set of pre-defined rules related to posting a listing in a second region, the processed listing being modified to produce a second version of the listing, push the second version of the listing to a server in the second region, and make the second version of the listing available for viewing by a second user in the second region.

10. The system as claimed in claim 9 wherein the advertising distribution module being further configured to obtain the listing by performing a screen-scraping operation.

11. The system as claimed in claim 9 wherein the advertising distribution module being further configured to obtain the listing by performing an access to an ad source via an application programming interface (API).

12. The system as claimed in claim 9 wherein the advertising distribution module being further configured to process the listing by performing a currency conversion operation on an object included in the listing.

13. The system as claimed in claim 9 wherein the advertising distribution module being further configured to process the listing by performing a time conversion operation on an object included in the listing.

14. The system as claimed in claim 9 wherein the advertising distribution module being further configured to process the listing by performing a language conversion operation on an object included in the listing.

15. The system as claimed in claim 9 wherein the advertising distribution module being further configured to track an ad source to determine if new ads have been posted or deleted from the ad source.

16. The system as claimed in claim 9 wherein the first region and the second region are in different countries.

17. A machine-useable storage medium embodying instructions which, when executed by a machine, cause the machine to:
obtain a listing posted by a first user in a first region;
process the listing according to a set of pre-defined rules related to posting a listing in a second region, the processed listing being modified to produce a second version of the listing;
push the second version of the listing to a server in the second region; and
make the second version of the listing available for viewing by a second user in the second region.

18. The machine-useable storage medium as claimed in claim 17 wherein the instructions being further configured to obtain the listing by performing a screen-scraping operation.

19. The machine-useable storage medium as claimed in claim 17 wherein the instructions being further configured to obtain the listing by performing an access to an ad source via an application programming interface (API).

20. The machine-useable storage medium as claimed in claim 17 wherein the instructions being further configured to track an ad source to determine if new ads have been posted or deleted from the ad source.
